(19) United States
(12) Patent Application Publication
(10) Pub. No.: US 2005/0265719 A1
(43) Pub. Date: Dec. 1, 2005

(54) Optical line termination, optical access network, and method and apparatus for determining network termination type

(76) Inventor: Marc R. Bernard, Pembroke Pines, FL (US)

Correspondence Address: PILLSBURY WINTHROP SHAW PITTMAN LLP, P.O. BOX 10500, MCLEAN, VA, 22102, US

(21) Appl. No.: 10/856,339

(22) Filed: May 27, 2004

(51) Int. Cl. H04B 10/20

(52) U.S. Cl. 398/58

(57) ABSTRACT

A method according to an embodiment of the invention includes receiving a string of symbols that uniquely identifies an optical networking unit (ONU) (e.g. a serial number of the ONU). Based on the received string of symbols, at least one attribute of the ONU is determined.

### FIELD OF THE INVENTION

The invention relates to communications networks.

### BACKGROUND

The following acronyms may appear in the description below: ADSL, asymmetric digital subscriber line (DSL); APON, asynchronous transfer mode (ATM) passive optical network (PON); ASIC, application-specific integrated circuit; ATM, asynchronous transfer mode; B-PON or BPON (broadband PON); CATV, community access television (cable television); CPU, central processing unit (e.g. microprocessor); EPON (Ethernet PON); FPGA, field-programmable gate array; HDSL, high-bit-rate DSL; IDSL, integrated services digital network (ISDN) DSL; PON, passive optical network; POTS, plain old telephone service; PPV, pay per view; RAM, random-access memory; ROM, read-only memory; SDSL, single-pair symmetrical services DSL; VoIP, voice over Internet Protocol; VoATM, voice over ATM; VoD, video on demand.

Optical access systems offer a potentially large bandwidth as compared to copper-based access systems. A broadband optical access system may be used, for example, to distribute a variety of broadband and narrowband communication services from a service provider's facility to a local distribution point and/or directly to the customer premises. These communication services may include telephone (e.g. POTS, VoIP, VOATM), data (e.g. ISDN, Ethernet), and/or video/audio (e.g. television, CATV, PPV, VoD) services.

FIG. 1 shows examples of two optical access network (OAN) architectures. The first example includes an optical line termination (OLT), an optical distribution network (ODN), an optical network unit (ONU), and a network termination (NT). The OLT provides the network-side interface of the OAN (e.g. a service node interface or SNI), and it may be located at a carrier's central office or connected to a central office via a fibre trunk (e.g. the OLT may include an OC-3/STM-1 or OC-12c interface).

The OLT may be implemented as a stand-alone unit or as a card in a backplane. The AccessMAX OLT card of Advanced Fibre Communications (Petaluma, Calif.) is one example of a superior OLT product. Other examples of OLTs include the 7340 line of OLTs of Alcatel (Paris, France), the FiberDrive OLT of Optical Solutions (Minneapolis, Minn.), and assemblies including the TK3721 EPON media access controller device of Teknovus, Inc. (Petaluma, Calif.). The OLT may communicate (e.g. via cable, bus, and/or data communications network (DCN)) with a management system or management entity, such as a network element operations system (NE-OpS), that manages the network and equipment.

On the user side, the OLT may be connected to one or more ODNs. An ODN provides one or more optical paths between an OLT and one or more ONUs. The ODN provides these paths over one or more optical fibres which may have lengths measured in feet or in kilometers. The ODN may also include optional protection fibres (e.g. for backup in case of a break in a primary path).

An optical network unit (ONU) is connected to an ODN and provides (either directly or remotely) a user-side interface of the OAN. The ONU, which may serve as a subscriber terminal, may be located outside (e.g. on a utility pole) or inside a building. One or more network terminations (NTs) are connected to an ONU (e.g. via copper trace, wire, and/or cable) to provide user network interfaces (UNIs), e.g. for services such as Ethernet, video, and ATM. implementations of such an architecture include arrangements commonly termed Fibre to the Building (FTTB), Fibre to the Curb (FTTC), and Fibre to the Cabinet (FTTCab).

One example of an ONU includes the XN230 APON media access controller device of BroadLight Ltd. (Ramat-Gan, Isreal) combined with an external CPU (and possibly other devices including an optoelectronic interface and interfaces for one or more of ATM, Ethernet, T1, video, and POTS). The XN230 device may be used to provide up to five logical ONUs. Another example of an ONU includes the MC92701 BPON layer termination device of Motorola Inc. (Schaumberg, Ill.) combined with an external CPU.

The second architecture example in FIG. 1 includes an OLT, an ODN, and one or more optical network terminations (ONTs). An ONT is an implementation of an ONU that includes a user port function. The ONT, which may be active, serves to decouple the access network delivery mechanism from the distribution at the customer premises (e.g. a single-family house or a multi-dwelling unit or business establishment). Implementations of such an architecture include arrangements commonly termed Fibre to the Home (FTTH). In some applications, an ONT may be wall-mounted.

The AccessMAX ONT of Advanced Fibre Communications (Petaluma, Calif.) is one example of a superior ONT product. Other examples of ONTs include the Exxtenz ONT of Carrier Access Corporation (Boulder, Colo.), the FiberPath 400 and 500 lines of ONTs of Optical Solutions, the 7340 line of ONTs of Alcatel, and assemblies including the TK3701 device of Teknovus, Inc.

As shown in FIG. 1, an OAN may include a number of ODNs connected to the same OLT. As shown in FIG. 2, an ODN may connect an OLT to multiple ONUs. An ODN may also be connected to both ONUs and ONTs. In some applications, the nominal bit rate of the OLT-to-ONU signal maybe selected from the rates 155.52 Mbit/s and 622.08 Mbit/s.

An ODN that contains only passive components (e.g. fibre and optical splitters and/or combiners) may also be referred to as a passive optical network (PON). Depending e.g. on the particular intended application, a PON may also be referred to as a B-PON (broadband PON), EPON (Ethernet PON), or APON (ATM PON). A OAN may include different OLTs and/or ONUs to handle different types of data traffic (e.g. Ethernet, ATM, video), and/or a single OLT or ONU may handle more than one type of data traffic. The OLT and/or one or more of the ONUs may be provided with battery backup (e.g. an uninterruptible power supply (UPS)) in case of mains power failure.

FIG. 3 shows an example of a OLT connected to a PON that includes a four-way splitter 20 and four eight-way splitters 30a-d. In this example, each of up to thirty-two ONUs may be connected to the PON via a different output port of splitters 30a-d (where the small circles represent the PON nodes depending from these ports). Other PON configurations may include different splitter arrangements. In some such configurations, for example, a path between the OLT and one ONU may pass through a different number of splitters than a path between the OLT and another ONU.

Operation of an OAN may include ranging. A ranging operation may be performed, for example, to quantify a time delay for transmissions between an OLT and ONU. A ranging operation may also include discovery of a newly installed ONU. Once an ONU has been successfully ranged, it becomes active on the network, and attribute information about the ONU is transmitted to the OLT. Ranging operations may be repeated at regular (e.g. about every fifteen seconds) and/or irregular intervals.

The protocol for communications between the OLT and the ONUs may be ATM-based (e.g. such that the OLT and ONUs provide transparent ATM transport service between the SNI and the UNIs over the PON), although embodiments of the invention as disclosed herein may also be applied to optical access networks in which such communications are based on other protocols (e.g. Ethernet). Embodiments of the invention may also be applied to optical access systems that comply with one or more of ITU-T Recommendations G.983.1 (“Broadband optical access systems based on Passive Optical Networks (PON),” dated October 1998 and as corrected July 1999 and March 2002 and amended November 2001 and March 2003, along with Implementor's Guide of October 2003) and G.983.2 (“ONT management and control interface specification for B-PON,” dated June 2002 and as amended March 2003, along with Implementor's Guide of April 2000) (International Telecommunication Union, Geneva, CH) and/or later versions of such Recommendations. Additional aspects of optical access systems to which embodiments of the invention may be applied are described in the aforementioned Recommendations.

### SUMMARY

A method according to one embodiment of the invention includes receiving a string of symbols associated with an optical networking unit (ONU). Based on the received string of symbols, at least one attribute of the ONU is determined.

An apparatus according to one embodiment of the invention includes a receiver and a determiner. The receiver is configured to receive a string of symbols associated with an ONU. The determiner is configured to determine, based on the received string of symbols, at least one attribute of the ONU.

### BRIEF DESCRIPTION OF THE DRAWINGS

FIG. 1 shows examples of two OAN architectures.

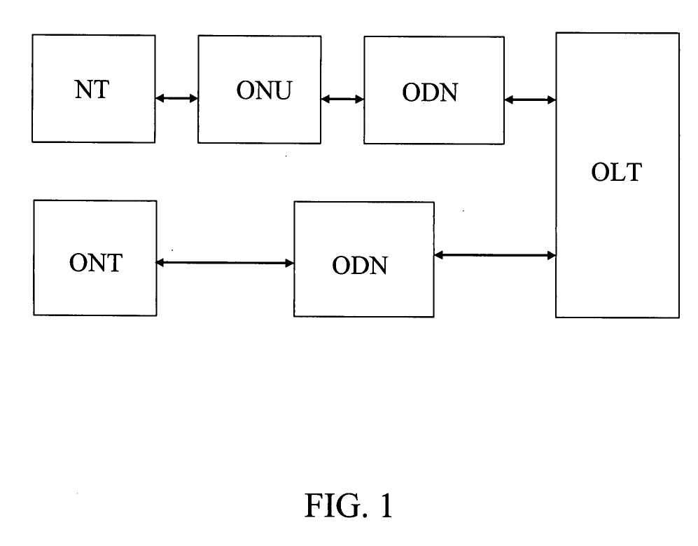

FIG. 2 shows an example of an OAN.

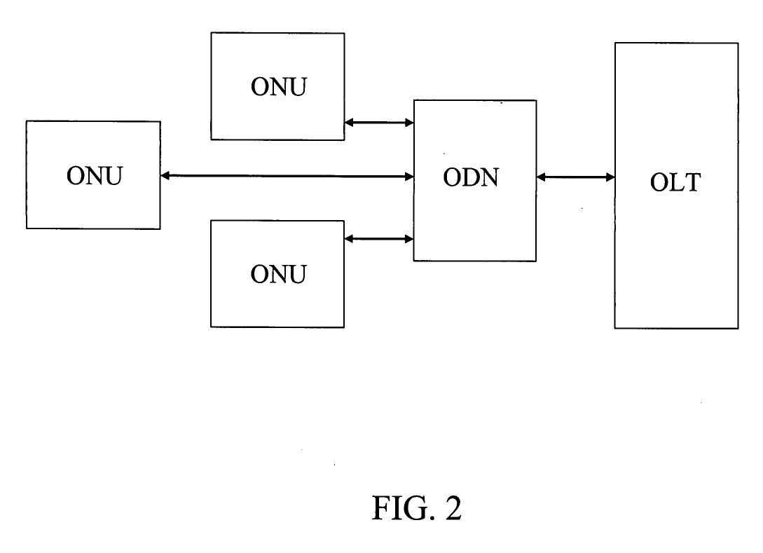

FIG. 3 shows an example of an OLT and a PON including splitters.

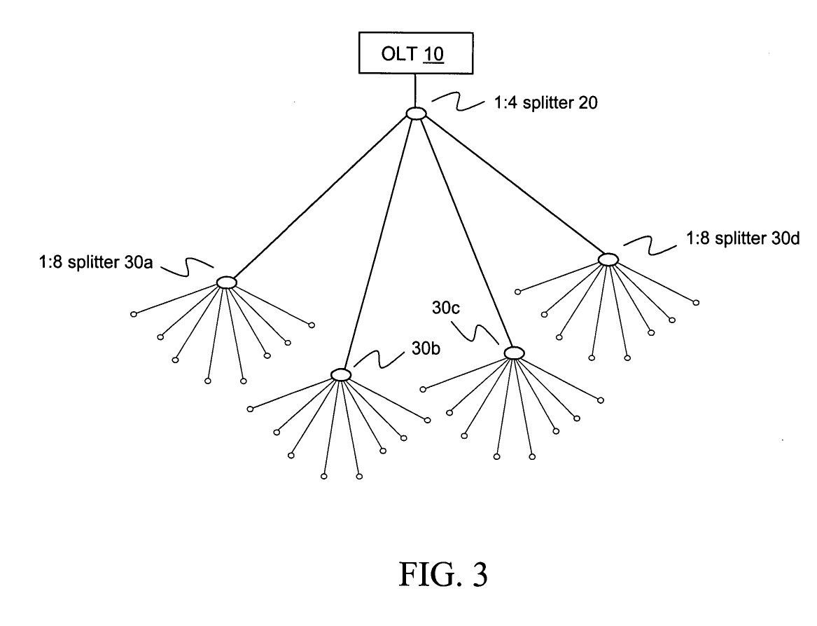

FIG. 4 shows an example interaction between an OLT and an ONU during a discovery process.

FIG. 5 shows a flowchart of a method according to an embodiment of the invention.

FIG. 6 shows a flowchart of a method according to an embodiment of the invention.

FIG. 7 shows a flowchart of a method according to an embodiment of the invention.

FIG. 8 shows an example ONU numbering model according to an embodiment of the invention.

FIG. 9 shows a flowchart of a method according to an embodiment of the invention.

FIG. 10 shows a module according to an embodiment of the invention.

FIG. 11 shows an OLT according to an embodiment of the invention.

FIG. 12 shows a system according to an embodiment of the invention.

FIG. 13 shows a system including a data storage medium according to an embodiment of the invention.

### DETAILED DESCRIPTION

A method according to an embodiment of the invention includes receiving (e.g. electronically) a string of symbols that uniquely identifies an optical networking unit (ONU). Based on the received string of symbols, at least one attribute of the ONU is determined.

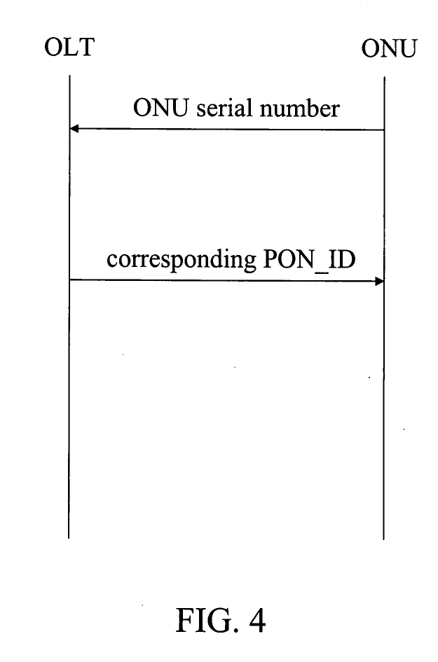

Embodiments herein may refer to an ONU serial number, such as that defined in G.983.1 referred to above. In G.983.1, a unique serial number is used to recognize an ONU during an ONU discovery process (e.g., ranging process) on a passive optical network (PON). That serial number may include the vendor ID and/or the version number of the subscriber line card, and is also utilized in G.983.2 referred to above. FIG. 4 shows an example interaction between an OLT and an ONU during a discovery process. The ONU sends its unique serial number to the OLT. The OLT assigns a corresponding PON_ID to the ONU, which PON_ID is then used by both the ONU and the OLT in subsequent operations and communications.

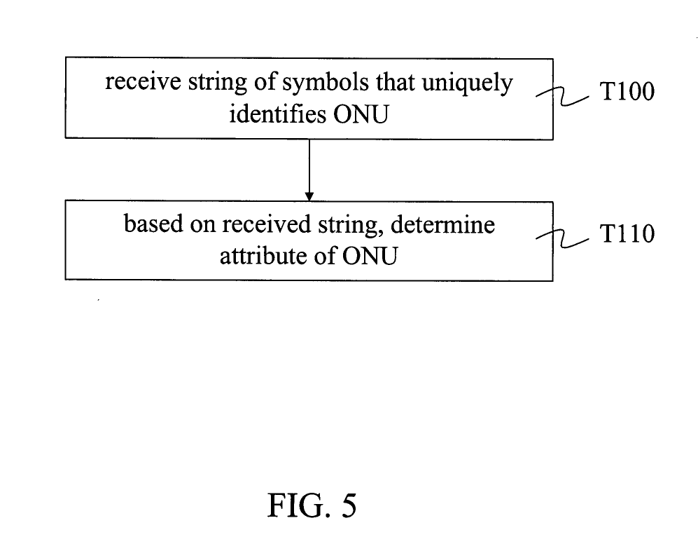

FIG. 5 shows a flowchart of a method according to an embodiment of the invention. Such a method may be performed by a module in an OLT, management system or entity, or other device or system operated by a service provider or other entity. In an integrated system such as a cabinet having one or more backplanes, the management system may include a control card or card assembly inserted into a backplane, and the OLT may include another card or card assembly inserted into the same or a different backplane. Such a backplane may include a standardized bus (e.g. ISA, PCI, VME, VxI) and/or a proprietary or otherwise non-standardized bus. Alternatively, the management system or entity may be external to the OLT and associated equipment, comprising for example, a command-line interface (CLI) or operational support system (OSS).

Task T100 receives a string of symbols associated with an ONU. The string of symbols may include a combination of numbers, letters, and/or non-alphanumeric characters. The string of symbols may constitute, for instance, a serial number of the ONU, a password of the ONU, an encryption key, and/or a part number of the ONU. The string of symbols may be received from an ONU and/or from another device. For instance, the string of symbols may be stored in a nonvolatile memory (e.g. ROM, flash RAM, ferroelectric RAM, magnetoresistive RAM) that is part of the ONU or accessible to the ONU. Alternatively or additionally, the string of symbols may be acquired via an input device of the ONU (e.g. a keyboard or keypad), or via an input mechanism (e.g. a keyboard, keypad, or touch screen) of a wireless device (e.g. a PDA) that communicates with task T100. Where multiple strings of symbols are received, combinations of input devices may be employed. For instance, a serial number may be received from nonvolatile memory of the ONU, and a password may be entered via a user interface.

Task T110 determines an attribute of the ONU based on the received string of symbols. Examples of such attributes include, for instance, a function or service supported by the ONU and a set of more than one such functions and/or services that are supported by the ONU.

Task T110 may determine the ONU attribute in various ways, such as those described herein or later developed. For instance, task T110 may consult a set of associations between strings of symbols and attributes (e.g., a table of associations); apply an algorithm involving at least the string of symbols (or a derivation or portion thereof) as input; and/or apply a bitmask to the string of symbols (or a derivation or portion thereof). At least some implementations of a method as shown in FIG. 5 may be performed before an ONU is ranged and active in a network.

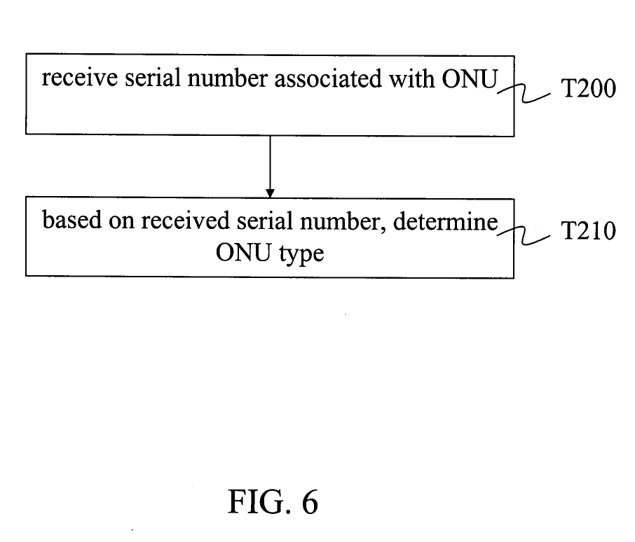

FIG. 6 shows a flowchart of a method according to an embodiment of the invention. The method may be a particular implementation of the method shown in FIG. 5. Task T200 receives a serial number associated with an ONU. Task T210 determines the ONU type based on the received serial number.

In an embodiment of the invention, ONU types are defined to indicate particular sets of functions and/or services supported by ONUs. Such defined ONU types may be standardized or may be specific to a manufacturer or service provider. For instance, a defined ONU type of Single Family Home Unit (SFU) may support four POTS lines, one Ethernet data line, and one CATV line. Similarly, a Multi-Dwelling Unit 1 (MDU1) ONU type may support a CATV line with additional (e.g. twenty-four total) POTS lines and (e.g. eight total) Ethernet data lines, while a MDU2 type may additionally support one or more (e.g. two) T1 lines. A business unit (e.g. Small Business Unit 1 (SBU1)) ONU type may support a combination of POTS, Ethernet, and T1 services (e.g. eight, twenty-four, and two lines, respectively).

Such ONU types may then be associated with ranges of ONU serial numbers such that one digit (or multiple digits) of a serial number can be used to identify the ONU type of the ONU. In an example implementation, an ONU serial number has eight serial number digits in conformance with G.983.1 referenced above, and seven types of ONUs are defined and associated with ranges of ONU serial numbers, as follows:

| Range of ONU Serial Numbers | ONU Type |
|---|---|
| 0-10000000 | SFU—Single Family Home Unit |
| 10000001-20000000 | MDU1—Multi-Dwelling Unit 1 |
| 20000001-30000000 | MDU2—Multi-Dwelling Unit 2 |
| 30000001-40000000 | MDU3—Multi-Dwelling Unit 3 |
| 40000001-50000000 | SBU1—Small Business Unit 1 |
| 50000001-60000000 | SBU2—Small Business Unit 2 |
| 60000001-70000000 | SBU3—Small Business Unit 3 |

Accordingly, given a serial number, the corresponding ONU type may be determined. Thus, given the corresponding serial number, an OLT (or other entity) can receive valuable information about an ONU (e.g., number and type of lines supported) before the ONU has been provisioned or even ranged (or possibly even before the ONU has been connected to the PON). Because an ONU type may identify functions supported by a particular ONU, the OLT can provide for the supply of appropriate services to the ONU, such as services contracted for by the ONU customer. Such an approach can facilitate network planning and validation before ranging.

ONU serial number bytes may be extended to support hexadecimal ranges. ONU type ranges similarly may be extended. For example, the range of serial numbers corresponding to an ONU of SFU type may be 0-1fffffff in hexadecimal, which is equivalent to 0-536870911 in decimal.

In an embodiment, ONU types may correspond in certain respects to subscriber line card types that are defined in Table 3 of G.983.2 referred to above, and maintained as a managed entity attribute by an ONU in accordance with G.983.2.

A method according to FIG. 6, or other methods disclosed herein, may be employed in connection with replacement of an existing ONU in the field. In particular, the serial number (or other string(s) of symbols) of a replacement ONU may be used to determine whether the replacement ONU is compatible with the unit being replaced. Based on a serial number entered for the replacement ONU, an OLT may validate and indicate to a user if the intended replacement ONU is compatible with the unit being replaced, and/or if some or all services are incompatible. For example, the ONU type may be compared with the stored type of the previous ONU. As such, errors in the field may be reduced (and/or a replacement operation may be simplified) for a service provider that needs to replace an existing ONU.

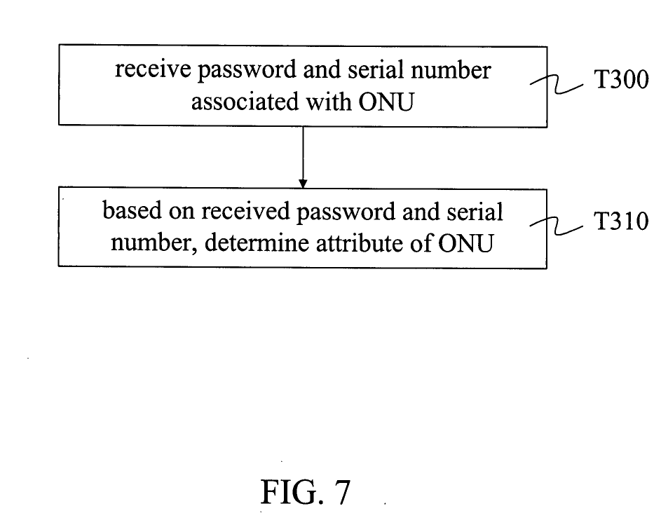

In an embodiment, a password and serial number combination is used to determine an attribute of an ONU, such as an ONU type. FIG. 7 shows a flowchart of a method according to an embodiment of the invention. Task T300 receives a password and serial number associated with an ONU. Task T310 determines an attribute of the ONU based on the received password and serial number. In an embodiment, task T310 may be performed by an OLT.

For example, a password may be defined to conform with a version of the G.983.1 Recommendation referred to above. The password may be associated with an ONU serial number using, for example, a predefined relationship that identifies the corresponding ONU type. Such a relationship may involve private key encryption/decryption (symmetric cryptography) or public key encryption/decryption (asymmetric cryptography), which techniques may be employed as desired to combat eavesdropping, counterfeit ONUs, and/or theft of services.

One example of a formula that may be used to generate a password based on an ONU type and serial number is as follows:

$$password = {( \frac{encryption key}{serial number} )}^{ONU type ID} \times encryption key , \qquad ( 1 )$$

where the serial number and password may be consistent with G.983.1. The encryption key may be a user-defined value. The ONU type ID may be defined as follows:

| ONU Type | ID |
|---|---|
| SFU | 1 |
| MDU1 | 2 |
| MDU2 | 3 |
| MDU3 | 4 |
| SBU1 | 5 |
| SBU2 | 6 |
| SBU3 | 7 |
| SBU4 | 8 |

Using a generated password and serial number according to this example, a corresponding implementation of task T310 in FIG. 7 may determine the ONU type of an ONU using the following equation:

$$ONU type ID = \frac{ln ( password / encryption key )}{ln ( encryption key / serial number )} . \qquad ( 2 )$$

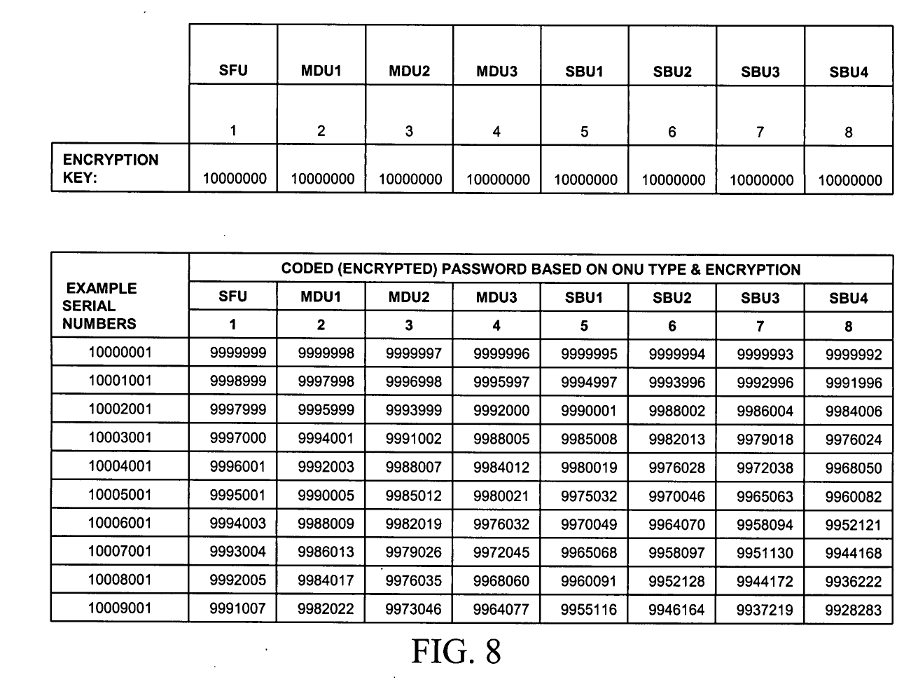

FIG. 8 shows an example ONU numbering model according to an embodiment of the invention. The model may relate to the above embodiments, wherein an ONU type is encoded in a password based on the ONU type, serial number and encryption key, and decoded based on the password, serial number, and encryption key. It is to be appreciated that the ONU serial numbers, passwords, types, and encryption keys depicted in FIG. 8 are merely provided as examples and are not intended to limit the inventive concepts disclosed herein.

To ensure that a valid password is generated, an encryption key may have different rules associated with it based on the serial number and the ONU type being coded or decoded. The same encryption key may be used for all ONU types to ensure that the ONU type can be decoded.

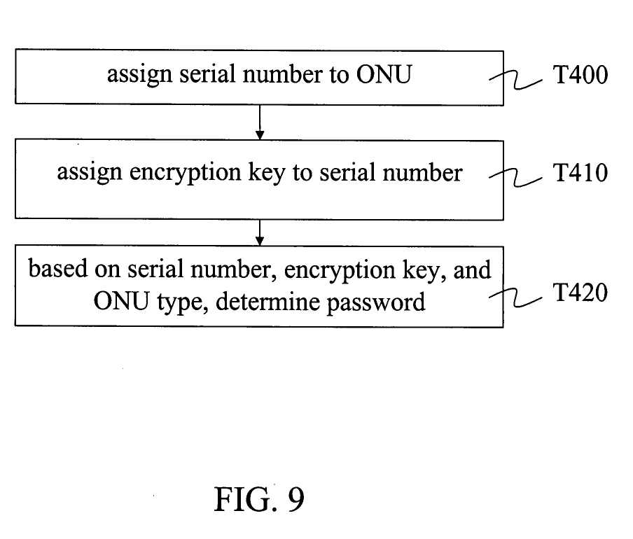

FIG. 9 shows a flowchart of a method according to an embodiment of the invention. Task T400 assigns a serial number to an ONU. Task T410 assigns an encryption key to the serial number. Task T420 determines a password based on the serial number, encryption key, and ONU type (e.g. via formula (1) above). Such a method may be performed, for example, during manufacturing of the ONU.

In one implementation of such a method, the serial number is affixed onto the exterior of the ONU, while the password is distributed in a more controlled fashion (e.g. affixed to the interior of the ONU, stored within the ONU, or provided only to a service provider purchasing the ONU). For example, a password common to several ONUs may be encoded into a portable device (such as a keyfob or key card) that communicates with the ONU electrically, optically, magnetically, or otherwise wirelessly and the distribution of which may be controlled. Once the ONU is deployed in the field, then the ONU type may be decoded by an OLT (e.g. via formula (2) above or another suitable formula).

In an embodiment, a password assigned to an ONU encodes information on services provided for the ONU. As such, when the password is received (such as in the method of FIG. 6 above), the password can be decoded to determine the provided services. For instance, the password may encode information about the ONU type. Alternatively or additionally, the password may encode relatively detailed information, such as codes associated with particular ONU functions or services. The below table lists example password byte codes for some example services.

| | Password Byte Code | | | | | |
|---|---|---|---|---|---|---|
| | | | | | | 6-10 |
| | | | | | | Other: |
| | 1 | 2 | 3 | 4 | 5 | Future |
| Byte | ONU | SERVICE: | SERVICE: | SERVICE: | SERVICE: | Services |
| Code | Type | POTS | Ethernet | T1 | CATV | (e.g., xDSL) |
| Values | 1: SFU1 | 1: 1-2 | 1: 1-2 Ports | 1: 1-2 Ports | 1: 1-2 Ports | |
| | 2: SFU2 | POTS | 2: 4 Ports | 2: 4 Ports | 2: 4 Ports | |
| | 3: MDU1 | 2: 4 POTS | 3: 8 Ports | 3: 8 Ports | 3: 8 Ports | |
| | 4: MDU2 | 3: 8 POTS | 4: 16 Ports | 4: 16 Ports | 4: 16 Ports | |
| | 5: MDU3 | 4: 16 POTS | 5: 24 Ports | 5: 24 Ports | 5: 24 Ports | |
| | 6: MDU4 | 5: 24 POTS | 6: 32 Ports | 6: 32 Ports | 6: 32 Ports | |
| | 7-f: etc. | 6: 32 POTS | 7-f: etc. | 7-f: etc. | 7-f: etc. | |
| | | 7-f: etc. | | | | |

Based on such a password format, information about an ONU can be determined without first provisioning the ONU within a network. In other embodiments, a password may be generated that is unique for each serial number and encodes information on provided services.

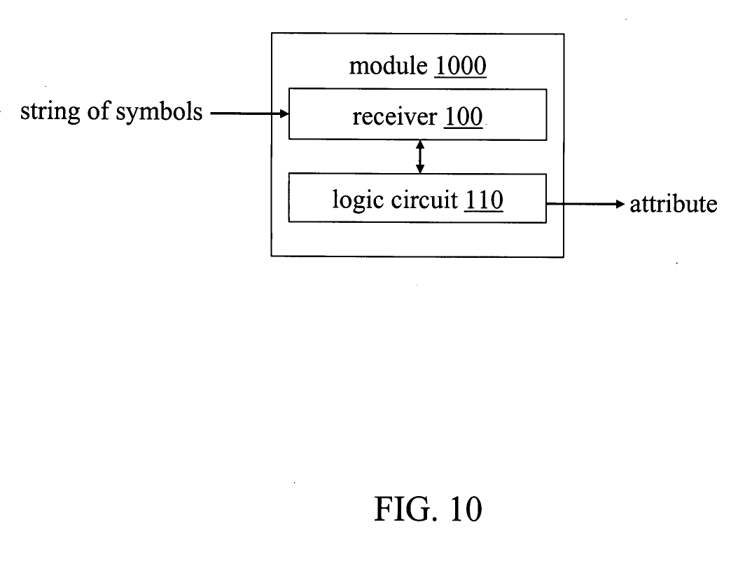

FIG. 10 shows a module 1000 according to an embodiment of the invention. Module 1000 may be implemented in an OLT, management system or entity, or other system or device. Module 1000 includes a receiver 100 and a logic circuit 110. Receiver 100 receives at least a string of symbols that uniquely identifies an ONU. For example, receiver 100 may include a demodulator and/or an optoelectronic converter (e.g. configured to receive the string optically, magnetically, or electronically) or a data entry device such as a keyboard, keypad, or touch screen. Logic circuit 110 determines at least one attribute of the ONU based on the received string of symbols. Logic circuit 110 may employ, for example, methods described herein to determine the at least one attribute of the ONU.

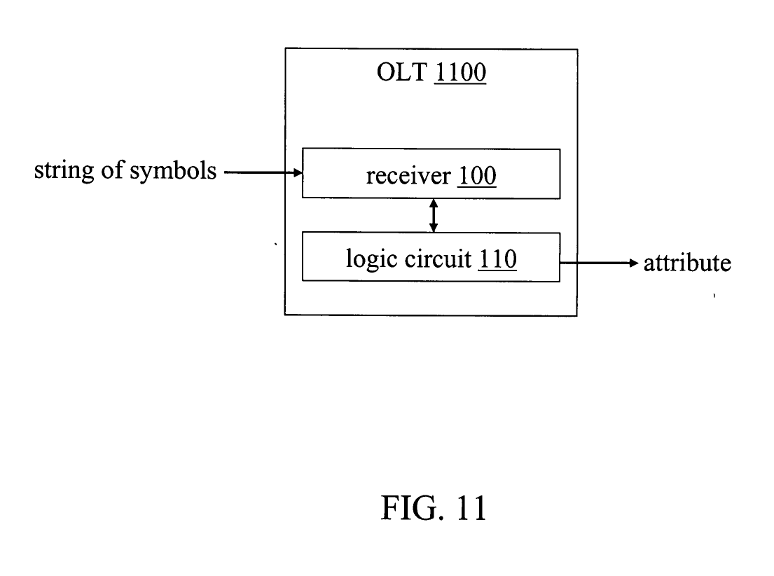

FIG. 11 shows an OLT 1100 according to an embodiment of the invention. OLT 1100 includes a receiver 100 and a logic circuit 110. Receiver 100 receives at least a string of symbols that uniquely identifies an ONU. Logic circuit 110 determines at least one attribute of the ONU based on the received string of symbols. The attribute may be used by the OLT in various ways, such as to facilitate provisioning of the ONU, network planning, and/or ONU replacement. In some applications, the attribute or information related to the attribute may be transmitted to the ONU or another system or device, such as a wireless device operated by a technician who is replacing or performing maintenance work on the ONU.

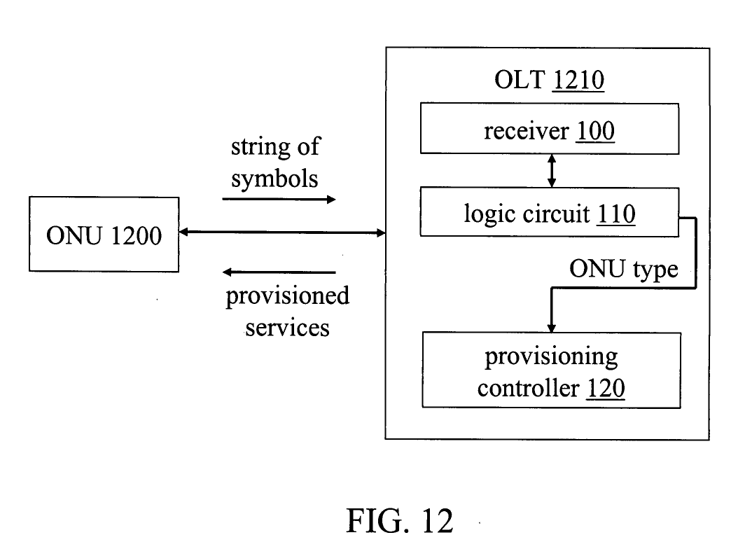

FIG. 12 shows a system according to an embodiment of the invention. The system includes an ONU 1200 and an OLT 1210. ONU 1200 is at some location in a passive optical network associated with OLT 1210. OLT 1210 includes a receiver 100, a logic circuit 110, and a controller 120.

In an embodiment of the invention, a predetermined set of supported and/or permitted services is associated with each defined ONU type. Such services may include any subscriber service associated with a given ONU type, such as POTS, Ethernet, CATV, T1, or xDSL. Accordingly, before ONU 1200 has been provisioned, ONU 1200 may send a string of symbols (e.g., a serial number) to OLT 1210. Receiver 100 in OLT 1210 receives the string of symbols. Based on the received string of symbols, logic circuit 110 determines the ONU type associated with ONU 1200. Based on the ONU type, controller 120 disallows provisioning of invalid services (e.g. services not in the set) to ONU 1200 and/or allows provisioning of valid services to ONU 1200. Thus, OLT 1210 need not wait until ONU 1200 is communicating with OLT 1210 and ONU 1200 indicates whether or not it can support a given service, and querying of ONU 1200 on a service-by-service basis may be avoided.

In an embodiment, one or more error indications (e.g. flags, conditions, or operator alarms or alerts) are issued by controller 120 (or another module in OLT 1210 ) and/or at ONU 1200 if the ONU type is unsuitable for particular services. Controller 120 may then allow ONU 1200 to be ranged but disallow e.g. invalid services.

Logic circuit 110 and controller 120 may be implemented using one or more integrated circuits (e.g. ASICs), FPGAs, or other chips or chipsets. Logic circuit 110 may be implemented as a fixed or programmable array of logic elements (e.g. an external or embedded processor) or as one or more sets of machine-executable instructions, while controller 120 may also be implemented in hardware (e.g. as a separate chip or as a part of an array including logic circuit 110) or in firmware or software (e.g. as one or more sets of instructions executing on OLT 1210, on the same array that executes logic circuit 110, or on a different processor). It is expressly contemplated that alternative operations and/or configurations of such elements, and that apparatus including additional elements, are disclosed by and may be constructed according to the description provided herein.

The foregoing presentation of the described embodiments is provided to enable any person skilled in the art to make or use the present invention. While specific embodiments of the invention have been described above, it will be appreciated that the invention as claimed may be practiced otherwise than as described. Various modifications to these embodiments are possible, and the generic principles presented herein may be applied to other embodiments as well.

An embodiment of the invention may be implemented in part or in whole as a hard-wired circuit (e.g. implemented on a computer interface card) and/or as a circuit configuration fabricated into one or more arrays of logic elements arranged sequentially and/or combinatorially and possibly clocked (e.g. one or more integrated circuits (e.g. ASIC(s)) or FPGAs). Likewise, an embodiment of the invention may be implemented in part or in whole as a firmware program loaded or fabricated into non-volatile storage (such as read-only memory or flash memory) as machine-readable code, such code being instructions executable by an array of logic elements such as a microprocessor or other digital signal processing unit.

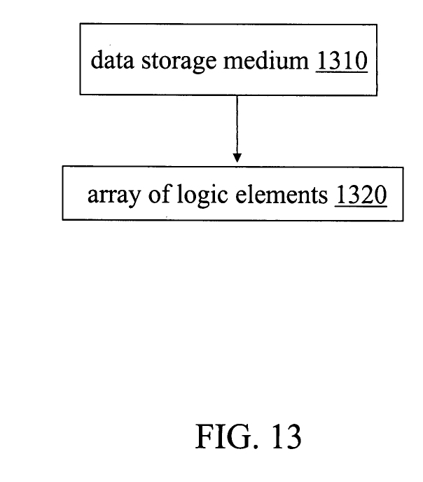

Further, an embodiment of the invention may be implemented in part or in whole as a software program loaded as machine-readable code from or into a data storage medium (e.g. as shown in FIG. 13) such as a magnetic, optical, magnetooptical, or phase-change disk or disk drive; or some form of a semiconductor memory such as ROM, RAM, or flash RAM, such code being instructions (e.g. one or more sequences) executable by an array of logic elements such as a microprocessor or other digital signal processing unit, which may be embedded into a larger device. Thus, the present invention is not intended to be limited to the embodiments shown above but rather is to be accorded the widest scope consistent with the principles and novel features disclosed in any fashion herein.

1. A method of data processing, said method comprising:
receiving a string of symbols that uniquely identifies an optical networking unit (ONU); and
based on the received string of symbols, determining at least one attribute of the ONU.

2. The method of data processing according to claim 1, wherein the string of symbols includes a serial number of the ONU.

3. The method of data processing according to claim 1, wherein said determining includes applying a bitmask to the received string of symbols.

4. The method of data processing according to claim 1, wherein said determining includes accessing a set of correspondences between strings of symbols and ONU attributes.

5. The method of data processing according to claim 1, wherein the at least one attribute comprises a type of the ONU.

6. The method of data processing according to claim 1, wherein the attribute identifies at least one service supported by the ONU.

7. The method of data processing according to claim 1, said method comprising receiving a password,
wherein said determining is based on the received password.

8. The method of data processing according to claim 1, wherein said receiving includes receiving the string of symbols from the ONU via an optical fiber.

9. The method of data processing according to claim 1, wherein said receiving includes receiving the string of symbols from the ONU via a passive optical network.

10. The method of data processing according to claim 9, said method comprising, subsequent to said receiving, ranging the ONU on the passive optical network for the first time.

11. The method of data processing according to claim 1, said method comprising, based on the at least one attribute, provisioning a service to the ONU.

12. The method of data processing according to claim 1, said method comprising comparing the at least one attribute to stored attribute information; and
based on a result of said comparing, provisioning a service to the ONU.

13. The method of data processing according to claim 1, said method comprising comparing the at least one attribute to stored attribute information; and
based on a result of said comparing, performing one among provisioning a service to the ONU and issuing an error indication.

14. The method of data processing according to claim 1, wherein said receiving includes receiving the string of symbols in encrypted form, and
wherein said determining includes decrypting the received string of symbols.

15. The method of data processing according to claim 1, wherein the string of symbols includes a password, and
wherein said determining is based on the password.

16. The method of data processing according to claim 15, wherein said determining includes applying a bitmask to the password.

17. A method of data processing, comprising:
assigning a serial number to an optical networking unit (ONU); and
based on an encryption key, associating a password with the ONU,
wherein at least one of the serial number and the password is based on at least one attribute of the ONU.

18. The method of data processing according to claim 17, said method comprising storing the serial number in a nonvolatile memory of the ONU.

19. The method of data processing according to claim 17, wherein at least one of the serial number and the password is based on at least one service supported by the ONU.

20. An apparatus comprising:
a receiver configured to receive a string of symbols that uniquely identifies an optical networking unit (ONU); and
a logic circuit configured to determine, based on the received string of symbols, at least one attribute of the ONU.

21. The apparatus according to claim 20, wherein the receiver is configured to receive the string of symbols in encrypted form, and
wherein the logic circuit is configured to decrypt the received string of symbols.

22. The apparatus according to claim 20, wherein the receiver is configured to receive a password, and
wherein the logic circuit is configured to determine the at least one attribute of the ONU based on the received password.

23. The apparatus according to claim 20, wherein the at least one attribute identifies at least one service supported by the ONU.

24. A data storage medium having instructions executable by an array of logic elements, said instructions describing a method of data processing, the method comprising:
receiving a string of symbols that uniquely identifies an optical networking unit (ONU); and
based on the received string of symbols, determining at least one attribute of the ONU.

25. The medium according to claim 24, wherein the string of symbols comprises a serial number of the ONU.

26. The medium according to claim 24, said method comprising receiving a password, wherein said determining is based on the received password.

27. The medium according to claim 24, wherein the attribute identifies at least one service supported by the ONU.

28. The medium according to claim 24, said method comprising, subsequent to said receiving, ranging the ONU on the passive optical network for the first time.

29. The medium according to claim 24, said method comprising, based on the at least one attribute, provisioning a service to the ONU.

30. The medium according to claim 24, said method comprising comparing the at least one attribute to stored attribute information; and
based on a result of said comparing, provisioning a service to the ONU.
